(19) United States
(12) Patent Application Publication
(10) Pub. No.: US 2008/0016924 A1
(43) Pub. Date: Jan. 24, 2008

(54) LOCK ASSEMBLY

(76) Inventor: Dwaine GOODWIN, Irvine, CA (US)

Correspondence Address: LEONG C LEI, PMB # 1008, 1867 YGNACIO VALLEY ROAD, WALNUT CREEK, CA, 94598, US

(21) Appl. No.: 11/458,111

(22) Filed: Jul. 18, 2006

(51) Int. Cl. F16K 35/00; G05G 5/00

(52) U.S. Cl. 70/175

(57) ABSTRACT

A lock assembly for an LPG cylinder which includes a receptacle configured to be threadedly engaged with an orifice of the LPG cylinder and a key configured to engage with the receptacle. The receptacle is provided at an end with a groove in which is fitted an O-ring and at the other end with external threads adapted to engage with internal threads of the orifice of the LPG cylinder. The receptacle has a primary cylindrical recess which has a bottom formed with a secondary cylindrical recess which is eccentric with respect to the primary cylindrical recess. The key has a primary cylindrical portion and a secondary cylindrical portion which is eccentric with respect to the primary cylindrical portion. The primary cylindrical portion of the key is dimensioned to fit into the primary cylindrical recess of the receptacle while the secondaty cylindrical portion is sized to engage with the secondary cylindrical recess of the receptacle.

### BACKGROUND OF THE INVENTION

(a) Field of the Invention

This invention is related to a lock assembly for LPG (low pressure gas) cylinders and in particular to one which can only be opened by a particular key.

(b) Description of the Prior Art

The conventional LPG cylinder has an orifice therein for containing gas. The orifice engages with a plug which prevents gas from exiting the LPG cylinder once the LPG cylinder is full. Nevertheless, the conventional plug is a threaded member which can rotate in or out of the LPG cylinder by any tool, such as a screwdriver or similar, thus making it easy to be opened by a third party.

Therefore,it is an object of the present invention to provide an improved lock assembly for LPG cylinder which can obviate and mitigate the above-mentioned drawbacks.

### SUMMARY OF THE INVENTION

This invention is related to an improvement in the structure of a lock assembly for LPG cylinders.

It is the primary object of the present invention to provide a lock assembly for and LPG cylinder which can only be opened by a specially designed key thereby preventing the LPG cylinder from being opened by a third party.

It is another object of the present invention to provide a lock assembly for an LPG cylinder which is simple in construction and low in cost.

According to a preferred embodiment of the present invention, there is provided a lock assembly for an LPG cylinder which includes a receptacle configured to be threadedly engaged with an orifice of the LPG cylinder, the receptacle provided at an end with a groove in which is fitted an O-ring, another end of the receptacle being formed with external threads adapted to engage with internal threads of the orifice of the LPG cylinder, the receptacle having a primary cylindrical recess which has a bottom formed with a secondary cylindrical recess which is eccentric with respect to the primary cylindrical recess, and a key having a primary cylindrical portion and a secondary cylindrical portion which is eccentric with respect to the primary cylindrical portion, the primary cylindrical portion of the key being dimensioned to fit into the primary cylindrical recess of the receptacle while the secondary cylindrical portion being sized to engage with the secondary cylindrical recess of the receptacle.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a lock assembly for LPG cylinders according to the present invention;

FIG. 2 is a perspective view illustrating how to engage the lock assembly with a LPG cylinder;

FIG. 3 is a perspective view of a LPG cylinder engaged with a receptacle of the lock assembly;

FIG. 4 is a sectional view illustrating the engagement between the receptacle;

FIG. 5 is a sectional view illustrating how to use the key to remove the receptacle;

FIG. 5A is a front view of the lock assembly shown in FIG. 4; and

FIG. 6 illustrates another preferred embodiment of the present invention.

### DETAILED DESCRIPTION OF THE PREFERRED EMBODIMENT

The following description are of exemplary embodiments only, and are not intended to limit the scope, applicability or configuration of the invention in any way. Rather, the following description provides a convenient illustration for implementing exemplary embodiment of the invention. Various changes to the described embodiments may be made in the function and arrangement of the elements described without departing from the scope of the invention as set forth in the appended claims.

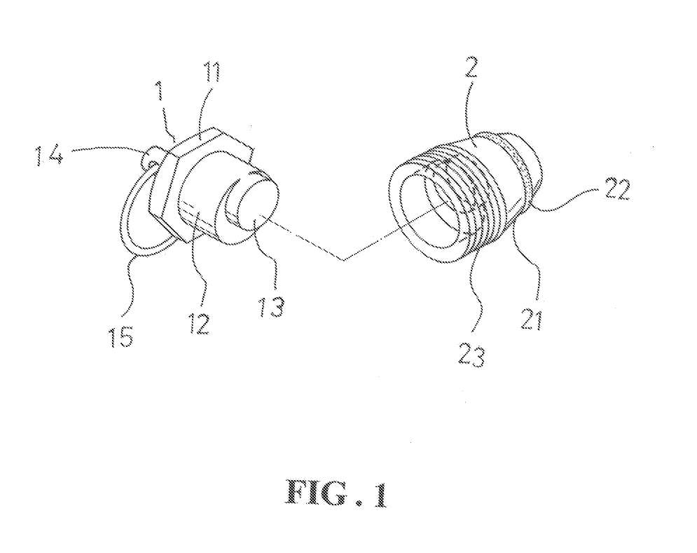

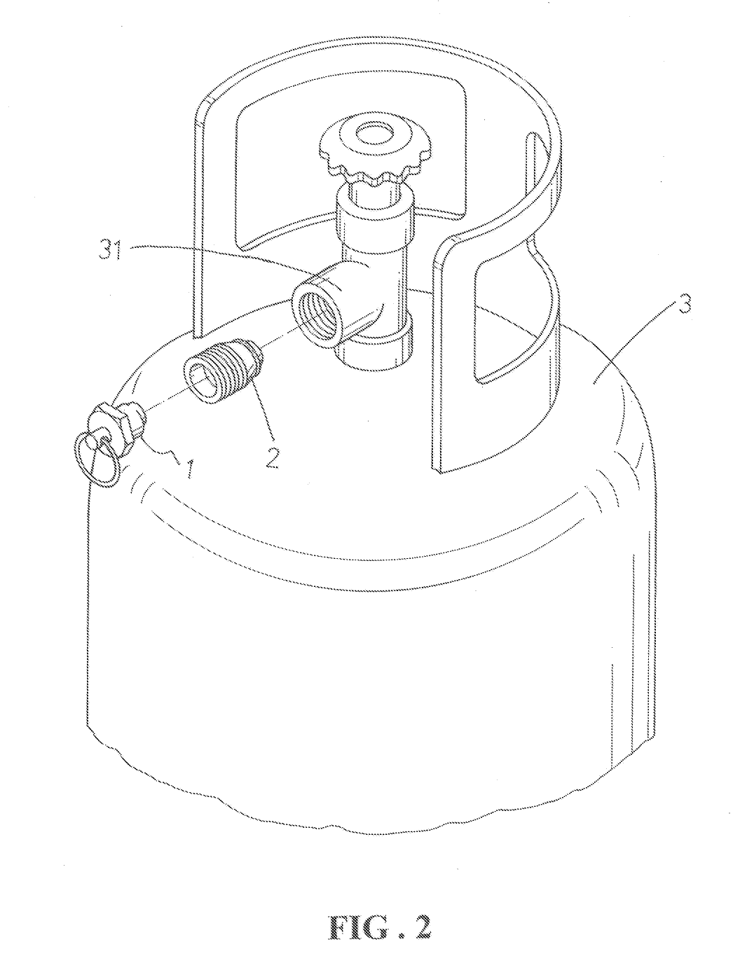

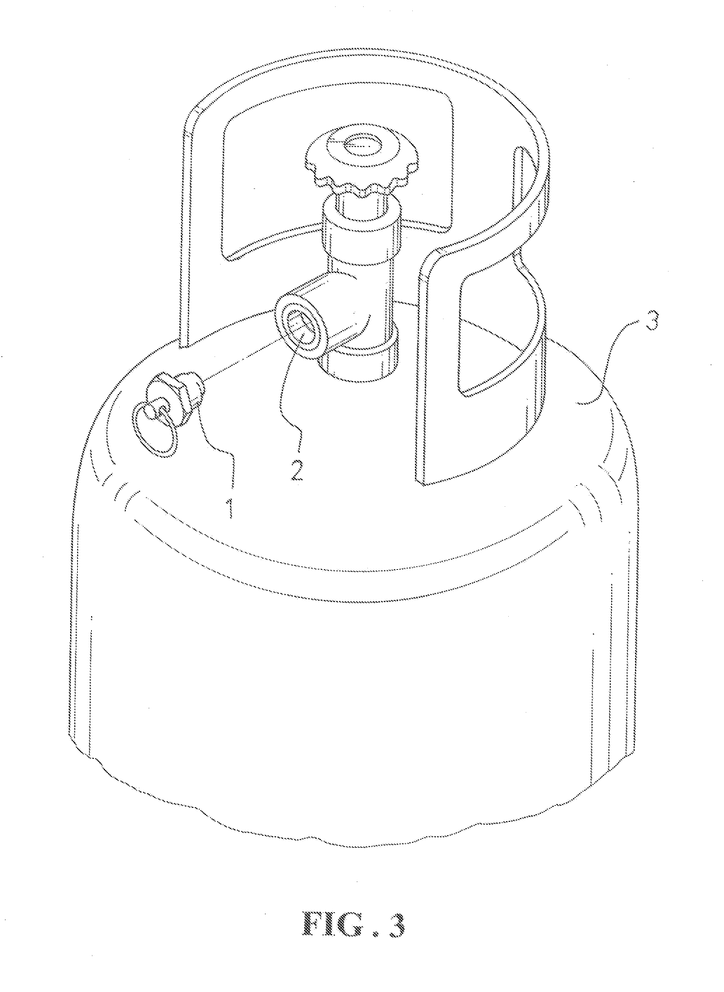

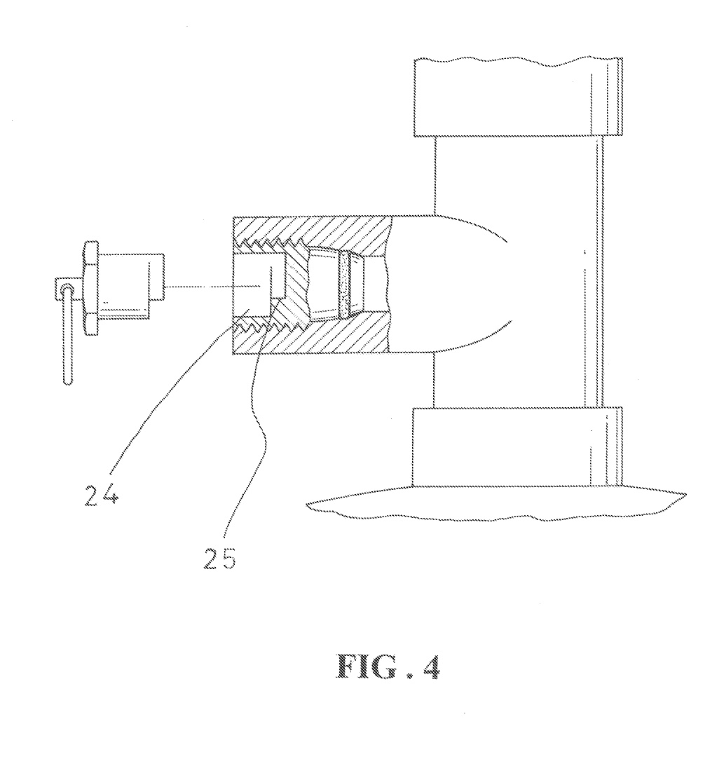

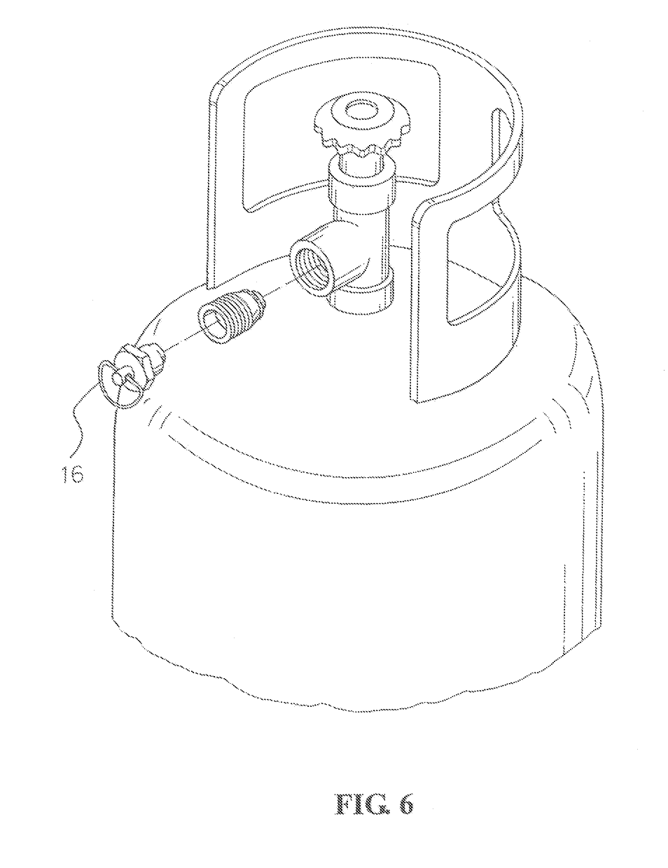

Referring to FIGS. 1 and 2, the lock assembly 10 comprises a key 1 and a receptacle 2. The receptacle 2 is configured to be threadedly engaged with an orifice 31 of an LPG (low pressure gas) cylinder 3. The receptacle 2 is provided at an end with a groove 21 in which is fitted an O-ring 22. The other end of the receptacle 2 is formed with external threads 23 adapted to engage with internal threads of the orifice 31 of the LPG cylinder 3. The receptacle 2 has a primary cylindrical recess 24 the bottom of which is formed with a secondary cylindrical portion 13 which is eccentric with respect to the primary cylindrical recess 24. The key 1 has a primary cylindrical portion 12 and a secondary cylindrical portion 13 which is eccentric with respect to the primary cylindrical portion 12. The primary cylindrical portion 12 of the key 1 is dimensioned to fit into the primary cylindrical recess 24 of the receptacle 2, while the secondary cylindrical portion 13 is sized to engage with the secondary cylindrical recess 25 of the receptacle 2. The key 1 has an enlarged head 11 provided at the center with a protuberance 14 which is mounted with a circular ring 15. The circular ring 15 may be replaced with a D-shaped ring (see FIG. 6).

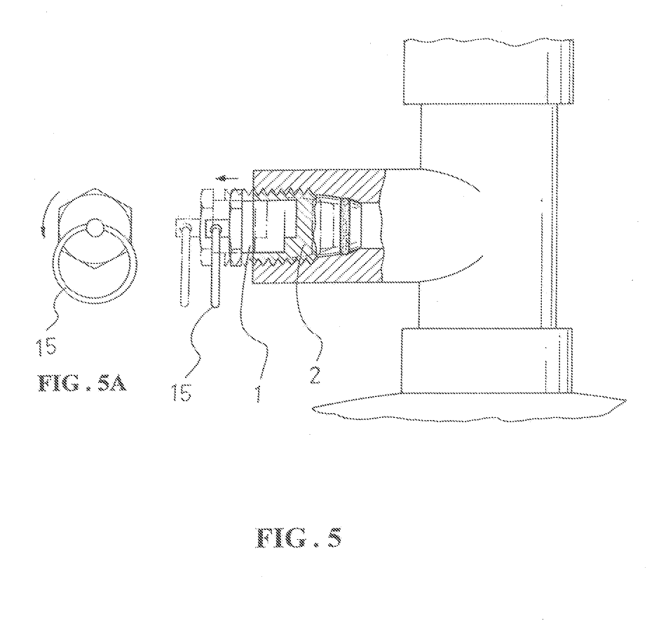

When in use, the receptacle 2 is first fitted in the orifice 31 of the LPG cylinder 3 and then the key 1 is inserted in the receptacle 2 to engage the primary cylindrical portion 12 and the secondary cylindrical portion 13 of the key 1 with the primary cylindrical recess 24 and the secondary cylindrical recess 25 of the receptacle (see FIGS. 2,3 and 4) Thereafter, the key 1 is turned to rotate the receptacle 2 into the orifice 31 thereby preventing gas from flowing out of the LPG cylinder 3 (see FIGS. 5 and 5A). Similarly, when desired to open the LPG cylinder 3 for use, it is only necessary to insert the key 1 into the receptacle 2 to engage the primary cylindrical portion 12 and the secondary cylindrical portion 13 of the key 1 with the primary cylindrical recess 24 and the secondary cylindrical recess 25 of the receptacle 2, and then the key 1 is turned to rotate the receptacle 2 out of the orifice 31 of the LPG cylinder 3.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim

1. A lock assembly for an LPG cylinder comprising:
a receptacle configured to be threadedly engaged with an orifice of said LPG cylinder, said receptacle provided at an end with a groove in which is fitted an O-ring, another end of said receptacle being formed with external threads adapted to engage with internal threads of said orifice of said LPG cylinder,said receptacle having a primary cylindrical recess which has a bottom formed with a secondary cylindrical recess which is eccentric with respect to said primary cylindrical recess; and
a key having a primary cylindrical portion and a secondary cylindrical portion which is eccentric with respect to said primary cylindrical portion, said primary cylindrical portion of the key being dimensioned to fit into said primary cylindrical recess of said receptacle while said secondary cylindrical portion being sized to engage with said secondary cylindrical recess of said receptacle.

2. The lock assembly for an LPG cylinder as claimed in claim 1, wherein said key is provided with an enlarged head.

3. The lock assembly for an LPG cylinder as claimed in claim 2, wherein said enlarged head is provided with a protuberance.

4. The lock assembly for an LPG cylinder as claimed in claim 3, wherein said protuberance is provided with a ring.

5. The lock assembly for an LPG cylinder as claimed in claim 4, wherein said ring is a circular member.

6. The lock assembly for an LPG cylinder as claimed in claim 4, wherein said ring is a D-shaped member.
